(19) United States
(12) Patent Application Publication
(10) Pub. No.: US 2009/0001142 A1
(43) Pub. Date: Jan. 1, 2009

(54) METHOD FOR PRODUCING A WELDED ROTOR OF A LOW-PRESSURE STEAM TURBINE

(75) Inventors: Ranjit Ramchandra Ballal, Ullesthorpe (GB); Herbert Bartsch, Dogern (DE); Sorin Keller, Oberrohrdorf (CH); Rodney William Vanstone, Rugby (GB)

Correspondence Address: DARBY & DARBY P.C., P.O. BOX 770, Church Street Station, New York, NY, 10008-0770, US

(73) Assignee: ALSTOM Technology Ltd, Baden (CH)

(21) Appl. No.: 12/144,137

(22) Filed: Jun. 23, 2008

Related U.S. Application Data
(63) Continuation of application No. PCT/EP2006/068235, filed on Nov. 8, 2006.

(30) Foreign Application Priority Data
Dec. 22, 2005 (CH) 02053/05

(51) Int. Cl. B23K 26/34

(52) U.S. Cl. 228/225

(57) ABSTRACT

A method for producing a welded rotor of a low-pressure steam turbine, the method including providing a first forging including a steel with a minimum yield strength of approximately 700 Mpa. A second forging is provided including a heat-treated 3.5 NiCrMoV stel having an average chemical composition of 3.5% of Ni, 1.5% of Cr, 0.35% of Mo, 0.10% of V, 0.25% of C, remainder Fe. A build-up layer of welding deposit is applied to a connection surface of the second forging using build-up welding. A first local post-weld stress-relief annealing is performed so as to soften the build-up layer and a corresponding heat-affected zone. The first and second forgings are joined together so as to provide a welding location. The welding location is filled using a welding deposit so as to provided a welded join. The welded join is subjected to a second post-weld stress-relief anneal.

### CROSS REFERENCE TO PRIOR APPLICATIONS

This application is a continuation of International Patent Application No. PCT/EP2006/068235, filed on Nov. 8, 2006 and claims benefit to SWISS Application No. CH 02053/05, filed on Dec. 22, 2005. The entire disclosure of both applications is incorporated by reference herein.

The present invention relates to the field of turbine engineering. It relates to a process for producing a welded rotor of a low-pressure steam turbine.

### BACKGROUND

It has long been known to produce rotors of steam turbines by joining a plurality of forgings along the rotor axis by welding. The individual forgings are in this case assigned to different temperature stages and can accordingly consist of different materials. In the past, various processes have been developed and proposed for the welding of forgings consisting of different materials, as described for example in U.S. Pat. No. 4,962,586, U.S. Pat. No. 6,152,697, U.S. Pat. No. 6,753,504 or EP 0 964 135.

FIG. 1 illustrates the configuration of a welded rotor of a low-pressure turbine as is known for example from the article by L. Bussse et al., “World's highest capacity steam turbosets for the lignite-fired Lippendorf power station”, ABB Review 6/1997, p. 14-15. The entire disclosure of this publication is incorporated by reference herein. The rotor 10 is assembled from a total of four forgings 11-14, which are connected to one another by welded joins 15, 16 along the rotor axis 18. The rotor 10 is symmetrical with respect to a center plane 23 that is perpendicular to the axis 18, with the steam being fed in the center plane 23 and flowing through the corresponding blading on both sides along the axis 18. The length of the blades increases towards the ends of the rotor 10. The longest blades are arranged on the outer forgings 11, 14 by means of a blade attachment 17. The efficiency of these last stages can be increased by augmenting the length of the associated blades. Since increasing forces act on the rotor blades attached to the rotor 10 as the length increases, the strength of the corresponding forgings has to be matched to the changing conditions.

Steel of type 2,3Cr2,2NiMo, having the chemical composition (on average) of 0.22% of C, 0.20% of Mn, 2.30% of Cr, 2.20% of Ni, 0.72% of Mo, remainder Fe, and a minimum yield strength of 700 MPa has hitherto been used as material with the highest strength for such welded rotors of low-pressure turbines. However, if the rotor blades in the end stage of the low-pressure turbine are to be lengthened to lengths in the range of over 100 cm, a stronger material is required for the outer forgings 11, 14.

Substituting the 2,3Cr2,2NiMo steel for a steel of higher strength without altering the associated post-weld stress-relief anneal process (PWHT, Post-Weld Heat Treatment), however, would lead to a high hardness of the heat-affected zone (HAZ) and therefore an increased risk of stress corrosion cracking (SCC). On the other hand, an increase in the PWHT temperature with a view to reducing the hardness in the heat-affected zone would reduce the strength of the forgings and of the welding deposit used. Local post-weld stress-relief annealing of the finished welded join at a higher temperature with a view to reducing the hardness in the heat-affected zone is likewise not possible, since the proximity of the blade attachment to the welded join would lead to the blade attachment overheating.

### SUMMARY OF THE INVENTION

An aspect of the present invention is to provide a method for producing a welded rotor of a low-pressure steam turbine which addresses the difficulties of previous processes and allows steels of higher strength which may be used without problems for the end stages of a low-pressure steam turbine, and may allow the use of longer rotor blades in the end stage.

An embodiment of the present invention provides that in a first step a first forging made from a steel with a minimum yield strength of approximately 700 MPa and a second forging made from a heat-treated 3.5 NiCrMoV steel with a typical chemical composition (on average) of 3.5% of Ni, 1.5% of Cr, 0.35% of Mo, 0.10% of V, 0.25% of C, remainder Fe, are provided, that in a second step a build-up layer of a welding deposit is applied to the connection surface of the second forging by means of build-up welding, that in a third step the applied welding deposit and the associated heat-affected zone are made softer by first local post-weld stress-relief annealing, that in a fourth step the first and second forgings are joined together to form a welding location, and the welding location is filled with welding deposit to form a welded join, and that in a fifth step the welded join is subjected to a second post-weld stress-relief anneal.

### BRIEF DESCRIPTION OF THE DRAWINGS

The present invention is to be explained in more detail below on the basis of exemplary embodiments in conjunction with the drawing, in which:

FIG. 1 shows a longitudinal section through the welded rotor of a low-pressure steam turbine as is suitable for carrying out the method according to the present invention; and

FIG. 2 in various subfigures 2a to 2e, shows various steps involved in carrying out the process according to the present invention.

### DETAILED DESCRIPTION

According to a configuration of the invention, the first forging consists of a steel of type 2,3Cr2,2NiMo with a chemical composition (on average) of 0.22% of C, 0.20% of Mn, 2.30% of Cr, 2.20% of Ni, 0.72% of Mo, remainder Fe.

In particular, the welding deposit used to fill the welding location may be NiCrMo steel with a chemical composition (on average) of max. 0.13 C, 0.3-0.8 Cr, 0.6-2.5 Ni, 0.4-0.8 Mo, max. 0.15 Co, max. 1.5 Mn, 0.5 Si, remainder Fe. In this case, the second post-weld stress-relief anneal carried out is in particular the standard post-weld stress-relief anneal for the welding deposit and the 2,3Cr2,2NiMo Steel at approximately 590° C.

In the context of the invention, however, it is also possible for the first forging to consist of a 3.5 NiCrMoV steel with a typical chemical composition (on average) of 3.5% of Ni, 1.5% of Cr, 0.35% of Mo, 0.10% of V, 0.25% of C, remainder Fe.

If, according to another configuration of the invention, the build-up layer is applied only to the outer edge of the connection surface. This may result in a shortened time for the post-weld stress-relief anneal.

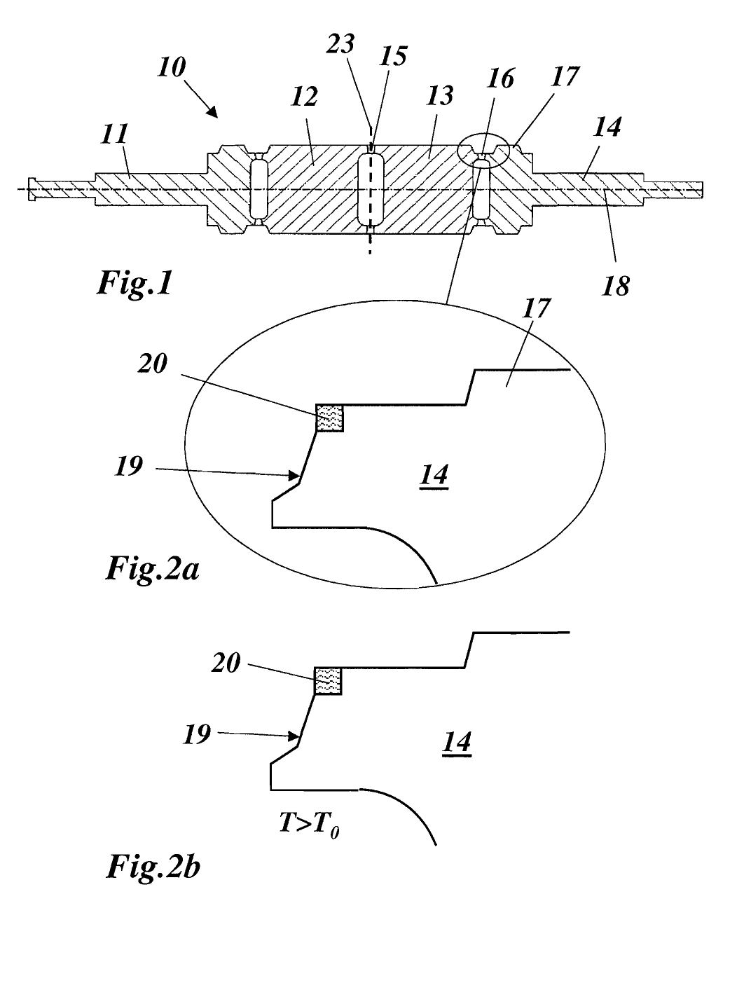

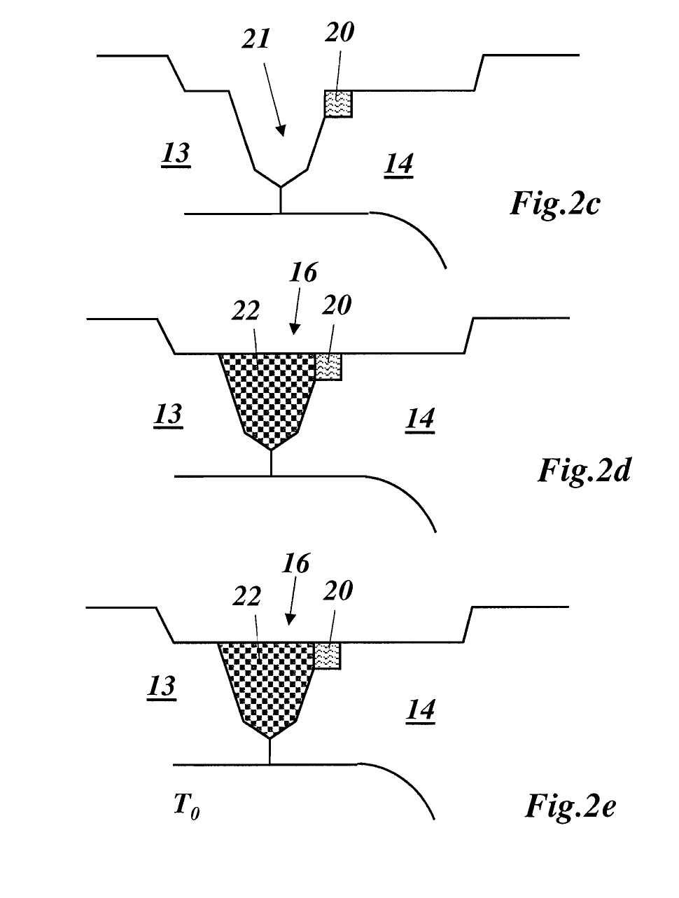

FIG. 2a shows an enlarged illustration of an excerpt from the forging 14 from FIG. 1 prior to welding. The forging 14, which consists of a tempered 3.5 NiCrMoV steel with a typical chemical composition (on average) of 3.5% of Ni, 1.5% of Cr, 0.35% of Mo, 0.10% of V, 0.25% of C, remainder Fe, has an annular connection surface 19 to which first of all a built-up layer 20 of welding deposit is applied, preferably restricted to its outer edge (FIG. 2a). Restricting the build-up layer 20 to the outer edge of the connection surface 19 has the advantage that it is possible to considerably shorten the time required for the subsequent post-weld stress-relief anneal (PWHT).

After the build-up layer 20 has been applied, the welding deposit of the build-up layer 20 and the associated heat-affected zone (HAZ) are subjected to a stress-relief anneal. This is indicated in FIG. 2b by the temperature indication T>T₀, where T₀ is the temperature of standard stress-relief anneal.

After the stress-relief anneal, the forgings 13 and 14 which are to be connected are joined together to form the weld location 21 (FIG. 2c). The weld location 21 is then filled with standard NiCrMo 2.5 welding deposit 22 having the chemical composition (on average) of max. 0.13 C, 0.3-0.8 Cr, 0.6-2.5 Ni, 0.4-0.8 Mo, max. 0.15 Co, max. 1.5 Mn, 0.5 Si, remainder Fe, in order to produce the welded join of the forging 14 to the forging 13 consisting of 2,3Cr2,2NiMo steel (FIG. 2d).

Finally, a standard stress-relief anneal (PWHT) at 590° C. is carried out on the welding deposit 22 and the 2,3Cr2,2NiMo steel (FIG. 2e).

An advantage of the present invention is that a rotor with a forging for the end stage with a minimum yield strength of 800 MPa is provided. Another advantage is that an acceptable hardness of the heat-affected zone results at the critical surface of the welded join (a higher hardness below the surface does not constitute any risk with regard to stress corrosion cracking). Another advantage is that there is no reduction in the strength in the forgings and in the welding deposit.

A welded join between a forging made from 2,3Cr2,2NiMo steel and a forging made from 3.5 NiCrMoV steel has been described in connection with FIG. 2. However, a similar process can also be carried out for joins between two forgings made from 3.5 NiCrMoV steel.

1. A method for producing a rotor of a low-pressure steam turbine, the method comprising:
providing a first forging including a steel with a minimum yield strength of approximately 700 MPa;
providing a second forging including a heat-treated 3.5 NiCrMoV steel having an average chemical composition of 3.5% of Ni, 1.5% of Cr, 0.35% of Mo, 0.10% of V, 0.25% of C, remainder Fe;
applying a build-up layer of a welding deposit to a connection surface of the second forging using build-up welding;
performing a first local post-weld stress relief-annealing so as to soften the build-up layer and a corresponding heat-affected zone;
joining together the first and second forgings so as to provide a welding location;
filling the welding location using a welding deposit so as to provide a welded join; and
subjecting the welded join to a second post-weld stress-relief anneal;

2. The method as recited in claim 1, wherein the first forging includes a 2,3Cr2,2NiMo steel having an average chemical composition of 0.22% of C, 0.20% of Mn, 2.30% of Cr, 2.20% of Ni, 0.72% of Mo, remainder Fe.

3. The method as recited in claim 2, wherein the welding deposit includes NiCrMo steel with an average chemical composition of up to 0.13% of C, 0.3-0.8% of Cr, 0.6-2.5% of Ni, 0.4-0.8% of Mo, up to 0.15% of Co, up to 1.5% of Mn, 0.5% of Si, remainder Fe.

4. The method as recited in claim 3, wherein the second post-weld stress-relief anneal is carried out approximately 590° C.

5. The method as recited in claim 1, wherein the first forging includes a 3.5 NiCrMoV steel with an average chemical composition of 3.5% of Ni, 1.5% of Cr, 0.35% of Mo, 0.10% of V, 0.25% of C, remainder Fe.

6. The method as recited in claim 1, wherein the build-up layer is applied only to an outer edge of the connection surface.
